(19) United States
(12) Patent Application Publication
(10) Pub. No.: US 2007/0289544 A1
(43) Pub. Date: Dec. 20, 2007

(54) GENERATOR OF CIRCULATIVE CURRENTS FOR AN AQUARIUM SYSTEM

(76) Inventor: CHI-CHENG MAO, Chaotou (TW)

Correspondence Address: G.LINK CO., LTD, 3550 BELL ROAD, MINOOKA, IL, 60447, US

(21) Appl. No.: 11/424,336

(22) Filed: Jun. 15, 2006

(51) Int. Cl. A01K 63/00

(52) U.S. Cl. 119/245

(57) ABSTRACT

A generator of circulative currents for an aquarium system includes a divisional barrel, a rotary inner barrel, a base valve, a water proof circular seat and an upper cover set. The divisional barrel has a receiving space with joining holes at the circumferential wall thereof and each joining hole engages with a divisional pipe. The rotary inner barrel is contained in the receiving space with at least a hole at the circumferential wall thereof. The base valve fits with the bottom of the divisional barrel with an inlet hole and provides a unidirectional valve member at the upper side thereof capable of blocking the inlet hole. The circular seat is disposed on the top of the rotary inner barrel to prevent from leakage. The upper cover set has a cover member and a cap member with the cover member closing and engaging with the top of the divisional barrel. A drive mover with a transmission shaft passes through both the cover member and the circular seat to connect with the top of the rotary inner barrel for the rotary inner barrel rotating with a proper speed. The cover member is covered with the cap member to protect the drive mover. When the water is admitted to enter the rotary inner barrel via the unidirectional valve member from the inlet hole of the base valve, the water is sent by the rotary inner barrel to the joining holes corresponding to the through holes and the water is sent to different joining holes while the rotary inner barrel is in rotation.

### BACKGROUND OF THE INVENTION

1. Field of the Invention

The present invention is related to a generator of circulative currents for an aquarium system and particularly to a generator of circulative currents, which is capable of producing multiple intermittent water current for obtaining an excellent environment for the living aquatic animals and plants in the aquarium system and filtering foreign objects in the aquarium system easily.

2. Brief Description of the Related Art

Usually, the aquarium has to be arranged an environment suitable for the bred living aquatic animals and plants therein. Especially, sea fishes or other feral species are extremely sensitive to the ambient factors of the environment such as quality of the water, water currents, light beam and temperature. Thus, to monitor the environment and the quality of the water in the aquarium is very important in order to allow the bred aquatic animals and plants growing safely and healthy. The present invention concerns the water currents. Conventionally, the water flowing to produce turbulent currents locally in the aquarium results from the water being sucked out by a filter system and sent back to the aquarium after passing through filtering stuff in the filter system. But, the currents being made in single wave type provide an unfavorable environment for the bred aquatic animals and plants especially for the aquatic species needing complex water currents. Hence, how to arrange an environment with water currents suitable for the bred aquatic animals and plants is an important subject worth us to note. Besides, the single wave type currents move is too slow while the water is sucked to the filter system. In this way, foreign objects in the water such as droppings of fish, feed residues, impurities and bacteria deposit at the bottom of aquarium instead of being filtered out. It is harmful to both quality of water and health of the bred aquatic animals and plants after the aquarium being a long period of time.

### SUMMARY OF THE INVENTION

An object of the present invention is to provide a generator of circulative currents for an aquarium system which is capable of producing multiple intermittent water currents for obtaining a high grade environment for the living aquatic animals and plants in the aquarium and for foreign objects in the aquarium capable of being filtered out easily.

### BRIEF DESCRIPTION OF THE DRAWINGS

The detail structure, the applied principle, the function and the effectiveness of the present invention can be more fully understood with reference to the following description and accompanying drawings, in which:

FIG. 1 is an exploded perspective view of a generator of circulative currents for an aquarium system according to the present invention;

FIG. 2 is another exploded perspective view of a generator of circulative currents for an aquarium system according to the present invention;

FIG. 3 is a sectional view of the generator of circulative currents for an aquarium system shown in FIGS. 1 and 2; and

FIG. 4 is a side elevational view illustrating an aquarium system being associated with the generator of circulative currents of the present invention.

### DETAILED DESCRIPTION OF THE INVENTION

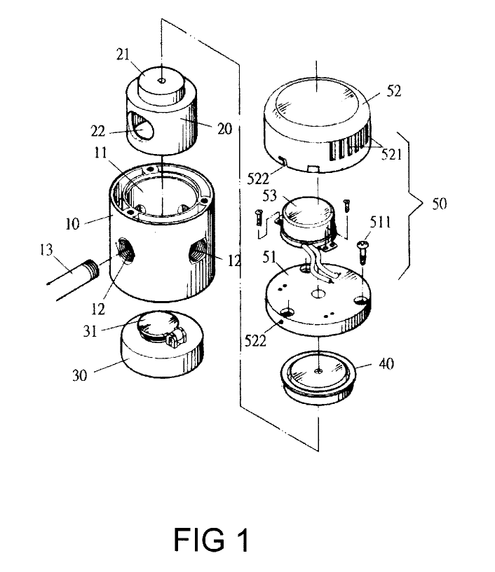

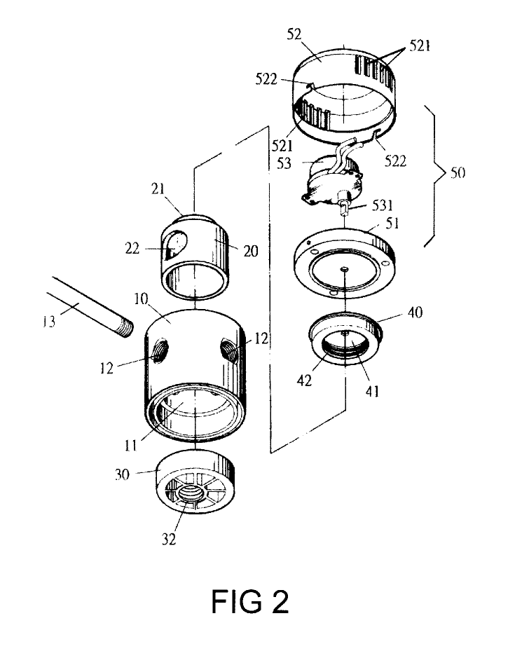

Referring to FIGS. 1 and 2, a generator of circulative currents for an aquarium system according to the present invention includes a divisional barrel 10, a rotary inner barrel 20, a base valve 30, a water proof circular seat 40 and an upper cover set 50.

Wherein, the divisional barrel 10 has a cylindrical receiving space 11 and the circumferential wall of the divisional barrel 10 provides two or more joining threaded holes 12 to communicate with the receiving space 11. Each of the joining threaded holes 12 engages with a divisional pipe 13.

The rotary inner barrel 20 is cylindrical with a closed top and a projection 21 is disposed at the closed top. The rotary inner barrel 20 is received in the receiving space 11 with the outer diameter thereof same as the inner diameter of the divisional barrel 10. The circumferential wall of the rotary inner barrel 20 provides one or more through holes 22.

The base valve 30 fits with the open bottom of the divisional barrel 10 and a unidirectional valve member 31 to close an inlet hole 32 at the center of the base valve.

The water proof circular seat 40 has a shape corresponding to the projection 21 with an upward recess part 41 and the inner wall surface of the recess part 41 is surrounded with at least a seal ring 42. The water proof circular seat 40 is disposed on the rotary inner barrel 20 with the recess part 41 fitting with the projection 21 and water leakage being resisted by the seal ring 42.

The upper cover set 50 includes a cover member 51 and a cap member 52. The cover member 51 closes the top of the divisional barrel 10 engages with the divisional barrel 10 with first fastening components 511 such as bolts, engaging projections and recesses or the like. A drive mover 53 has a transmission shaft 531 passes through both the cover member 51 and the water proof seat 41 to connect with the top of the rotary inner barrel 20 such that the rotary inner barrel 20 can rotate with a proper speed. The cover member 51 is further covered with the cap member 52 to protect the drive mover 53 and the cap member 52 is secured to the cover member 51 with second fastening components 522 such as bolts or the like. Heat dissipating openings 521 are provided at the cap member 52 for heat generated from the drive mover 53 being removed effectively.

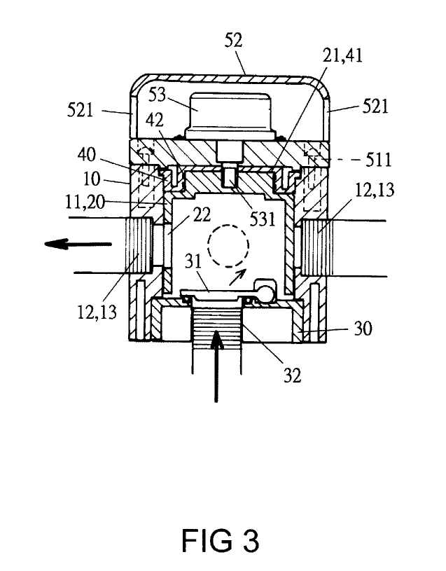

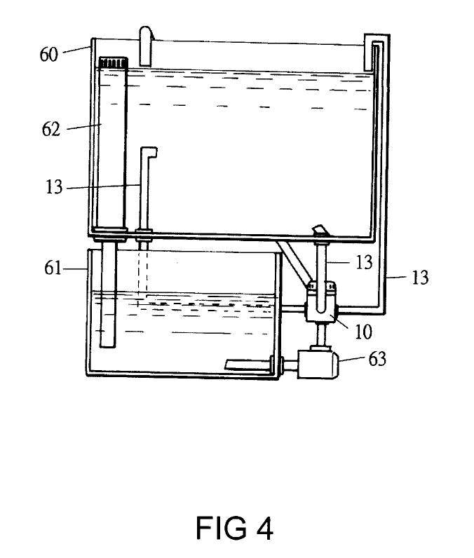

Referring to FIG. 3, the rotary inner barrel 20 is capable of rotating with a proper speed due to the drive mover 53 of the upper cover set 50 being powered on. When the water is admitted to enter the rotary inner barrel 20 via the unidirectional valve member 31 from the inlet hole 32 of the base valve 30, the water is sent by the rotary inner barrel 20 to the joining holes 12 corresponding to the through holes 22. Further, the water can be sent to different joining holes 12 while the rotary inner barrel 20 is in rotation. The generator of circulative currents for an aquarium system according to the present invention can be mounted to the pipe line of an aquarium system as shown in FIG. 4. The aquarium system includes a main aquarium 60 and a secondary aquarium 61 disposed underneath. The main aquarium 60 has an overflow pipe 62 to limit the water level inside and the overflow pipe 62 extends to the secondary aquarium 61 for receiving the overflow. A pump 63 can be employed to suck the water in the secondary aquarium 61 to the inlet holes 32 and the water flows outward via the divisional pipes 13. Further, the water enters the main aquarium 60 by means of part of the divisional pipes.

Besides, a conventional filter system can be employed instead of the overflow pipe 62 for guiding the water in the main aquarium 60 into the secondary aquarium 61. The water in the secondary aquarium 61 can be sucked with an immerged type pump or a pump disposed underneath to connect with the bottom of the secondary aquarium 61 with a pipe. The divisional pipes 13 are extended to the main aquarium 60 through the walls thereof or down from the open top thereof. The water outlet of the divisional pipes 13 can be arranged over the liquid lever or under the liquid lever of the main aquarium 60.

Due to the water in the secondary aquarium 61 being sucked out by the pump 63 and sent to the rotary inner barrel 20 via the unidirectional valve member 31 from the inlet hole 32 of the base valve 30, the water can flow outward via the joining holes 12 of the divisional barrel 10 and corresponding holes 22 of the rotary inner barrel 20 alternately while the rotary inner barrel 20 is in rotation. Hence, multidirectional intermittent water currents can be generated in the main aquarium 60 and spread all over the main aquarium 60. In this way, a high grade environment for the aquariums can be obtained and the water can be activated and oxygen therein can be increased substantially. Further, it is impossible for droppings of fish, feed residues, impurities or bacteria to deposit at the bottom of the main aquarium and it is easier for the filter device to capture them in order to maintain the water circulation effectively.

It is appreciated that the generator of circulative currents for an aquarium system according to the present invention is capable of generating multidirectional intermittent water currents repeatedly and is helpful for filtering out foreign objects.

While the invention has been described with referencing to preferred embodiments thereof, it is to be understood that modifications or variations may be easily made without departing from the spirit of this invention, which is defined by the appended claims.

What is claimed is:

1. A generator of circulative currents for an aquarium system, comprising:
a divisional barrel, having a cylindrical through receiving space with a plurality of joining holes at the circumferential wall thereof and each of the joining holes engaging with a divisional pipe;
a rotary inner barrel, being cylindrical with a closed top, having a size corresponding to the receiving space for being contained in the receiving space, and having at least a hole at the circumferential wall thereof;
a base valve, fitting with the bottom of the divisional barrel, having an inlet hole, and providing a unidirectional valve member at the upper side thereof capable of blocking the inlet hole;
a water proof circular seat, being disposed on the top of the rotary inner barrel for preventing from leakage; and
an upper cover set, further including a cover member and a cap member, the cover member closing the top of the divisional barrel, engaging with the divisional barrel, a drive mover with a transmission shaft passing through both the cover member and the water proof circular seat to connect with the top of the rotary inner barrel such that the rotary inner barrel rotates with a proper speed, the cover member being covered with the cap member to protect the drive mover;
whereby, when the water is admitted to enter the rotary inner barrel via the unidirectional valve member from the inlet hole of the base valve, the water is sent by the rotary inner barrel to the joining holes corresponding to the through holes and the water is sent to different joining holes while the rotary inner barrel is in rotation.

2. The generator of circulative currents for a aquarium system as defined in claim 1, wherein the rotary inner barrel is cylindrical with a closed top and a projection is disposed at the closed top; the water proof circular seat has an upward recess part and the inner wall surface of the recess part is surrounded with at least a seal ring and the water proof circular seat is disposed on the rotary inner barrel with the recess part fitting with the projection and water leakage being resisted by the seal ring.

3. The generator of circulative currents for an aquarium system as defined in claim 1, wherein the upper cover set engages with the divisional barrel by means of fastening components such as bolts or engaging projections and recesses.

4. The generator of circulative currents for an aquarium system as defined in claim 1, wherein a plurality of openings at the cap member for dissipating heat generated from the drive mover.

5. The generator of circulative currents for an aquarium system as defined in claim 1, wherein the cap member engages with the cover member by means of fastening components such as bolts or engaging projections and recesses.
